(19) United States
(12) Patent Application Publication
(10) Pub. No.: US 2018/0273358 A1
(43) Pub. Date: Sep. 27, 2018

(54) MOTOR-OPERATED CRANE DRIVE

(71) Applicant: FLENDER GMBH, Bocholt (DE)

(72) Inventor: Andreas KUBE, Aachen (DE)

(73) Assignee: FLENDER GMBH, Bocholt (DE)

(21) Appl. No.: 15/762,339

(22) PCT Filed: Sep. 23, 2016
(86) PCT No.: PCT/EP2016/072678

§ 371 Date: Mar. 22, 2018

(30) Foreign Application Priority Data
Sep. 23, 2015 (DE) 10 2015 218 300.9

(51) Int. Cl. B66D 5/02; B66D 1/12; B66D 1/14; B66D 1/54; B66C 15/00

(52) U.S. Cl. CPC B66D 5/02; B66D 1/12; B66D 1/14; B66D 2700/07; B66C 15/00; B66D 2700/0141; B66D 1/54

(57) ABSTRACT

The invention relates to a motor-operated crane drive in which a more rapidly rotating motor (1) drives a more slowly rotating cable drum (3) via a transmission (3). A safety brake (5) is arranged on the more slowly rotating side of the transmission (2). A signal that is used for actuating the safety brake (5) is utilized for initiating an electrical deceleration of the motor (1).

The present invention relates to a motor-driven crane drive and to a method for operating such a crane drive.

DE 3838058 A1 (Mannesmann AG) May 10, 1980 and EP 1 710 199 A1 (Shanghai Zhenhua Port Machinery Co. Ltd.) Oct. 11, 2006 disclose motor-driven crane drives in which a rapidly rotating motor drives a slowly rotating rope drum via a gear unit. With these drive trains it is known to arrange a service brake on the “fast side” of the gear unit, i.e. acting on the fast-running gear input shaft, and a safety brake on the “slow side” of the gear unit, i.e. acting on the slow-running gear output shaft. In today's known electric braking systems service brakes are seldom used as stopping brakes, but rather serve to hold the load secure. Safety brakes serve as additional safeguards for the system, for example in the event of a gear shaft breaking. Since the safety brake is generally arranged on a drum flange of the rope drum, i.e. at the load end of the rotating drive train, it is also designated a rope drum brake. Since the safety brake is capable, in addition to the service brake, of stopping and holding the load, it is also designated an auxiliary brake.

In crane drives there are various methods for stopping a lifting or lowering operation. In any event, a crane drive must have an emergency stop, by which actual or impending danger may be averted. Directive 2006/42/EC of the European Parliament and of the Council of May 17, 2006 on machinery and amending Directive 95/16/EC defines, in the Annex, clause 1.2.4.3, an emergency stop as a device for stopping the hazardous process as quickly as possible in the event of an emergency, without creating additional risks.

DIN EN 13135:2013-05 “Cranes—Safety—Design—Requirements for Equipment” indicates in Section 5.3.3.1 that, on activation of a Category 1 emergency stop, the service brake must automatically respond once the electric braking has brought movement to a stop.

It is known, in particular in the case of an emergency stop or emergency cutout, to activate the rope drum brake located on the slow side of the gear unit. This brake engages with a very short delay time, in order to bring the load transported by the crane as quickly as possible to a standstill. During this braking process, the rotating mass on the axis of the fast-running motor shaft, in particular of motor, clutch and brake drum or disk of the service brake, must be absorbed by the gear unit. This may lead to the gear unit experiencing a multiple of the rated torque as peak load. The torque peaks that occur require the gear unit to be larger than the maximum static load of the crane would need. Nonetheless, the peak loads are sometimes so great that they shorten the service life of the gear unit.

Vöth, Stefan, Lifting Mechanisms with Safety Brakes, Parts 1-3, in: Hebezeuge Fördermittel, Fachzeitschrift far Technische Logistik (Lifting Gear & Material Handling Systems, Specialist Journal for Industrial Logistics), ISSN 0017-9442, Berlin: Huss-Medien GmbH, 55 (2015), issue 3, pages 150 to 152; issue 4, pages 192 to 194; and issue 5, pages 254 to 255, www.hebezeuge-foerdermittel.de, suggests reducing the load in the drive train in the event of an emergency stop or emergency cutout in that the braking engagement of the service and/or safety brake proceeds as far as possible at the same time as motor cutout or the engagement of safety brake and service brake proceeds simultaneously or in coordinated manner.

It is an object of the invention to reduce the load acting on the gear unit during an emergency stop.

The object is achieved with a crane drive having the features stated in claim 1. The object is further achieved with a method having the features stated in claim 4. It is also possible for a corresponding method to be performed in the case of an emergency cutout.

The crane drive is a motor-driven crane drive. The crane drive comprises a drive motor, a gear unit and a rope drum. The term “rope drum” encompasses all other types of rotating lifting devices which use chains, belts etc., for example.

In this case, the gear unit is connected between the drive motor and the rope drum in such a way that rotation of the drive motor is geared down to slower rope drum rotation. The gear unit thus divides the crane drive into a faster-rotating part, also designated a faster-rotating side of the gear unit, and a slower-rotating part, also designated a slower-rotating side of the gear unit.

A safety brake is arranged on the slower-rotating side of the gear unit. It is possible for the safety brake to take the form of a disk brake arranged on the rope drum or a block or drum brake. In the crane drive a signal serving to trigger the safety brake is used to initiate electric braking of the drive motor, i.e. to generate a torque contrary to the current direction of rotation of the drive motor. A torque is therefore generated which reduces the speed of the motor and thus supports the action of the safety brake. The signal serving to trigger the safety brake is also designated an emergency stop signal.

The method comprises a method for operating a motor-driven crane drive, in which a faster-rotating drive motor drives a slower-rotating rope drum via a gear unit. A safety brake is in this case arranged on the slower-rotating side of the gear unit. A signal serving to trigger the safety brake, in particular as a result of actuation of an emergency stop switch, is used to initiate electric braking of the drive motor.

If the motor generates a braking torque at the same time as the safety brake response or shortly before, the inert mass to be braked by the safety brake and thus the peak load in the gear unit is reduced by a considerable amount. The exact level depends on the performance of the motor/converter combination, but amounts as a rule to no less than the simple rated torque. This is possible because the converters on crane drives are generally regenerative and are capable of feeding the kinetic energy of the motor regeneratively back into the grid.

Alternatively, the kinetic energy of the engine may be converted into thermal energy by a braking resistor. It is also possible to store the potential energy taken from the load in a mechanical storage system, for example in a spring or a flywheel mass.

The invention results in the load acting on the gear unit in the event of an emergency stop being reduced. Consequently, less gear unit damage arises and the gear unit or gear unit parts may be of smaller size. This results in particular in economic advantages and optionally higher drive availability.

The invention is explained below on the basis of an exemplary embodiment with reference to the drawings, in which, schematically and not to scale

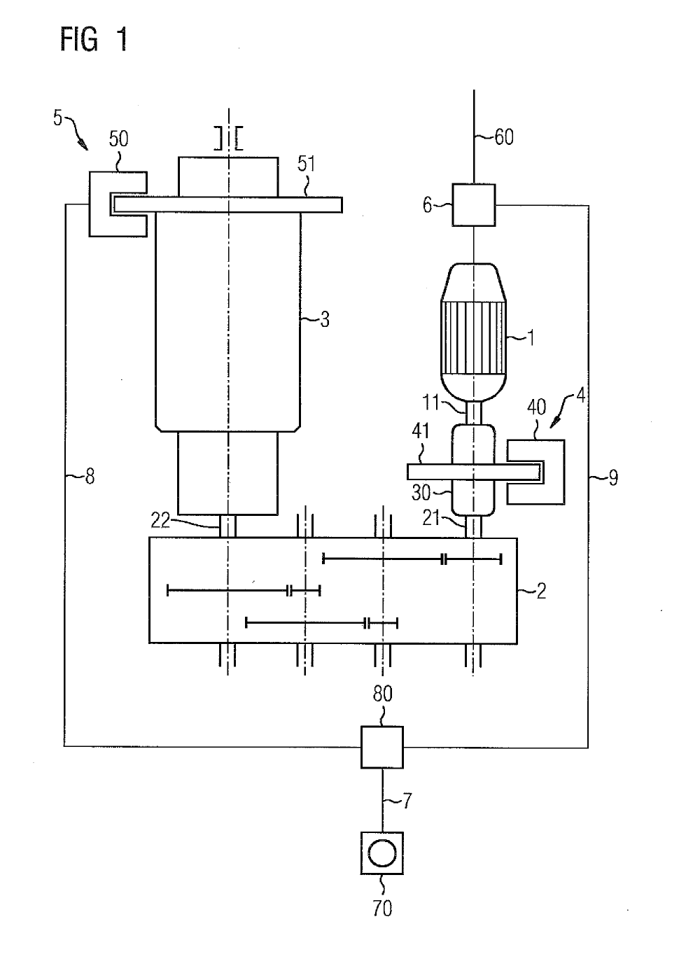

FIG. 1 shows a crane drive, and

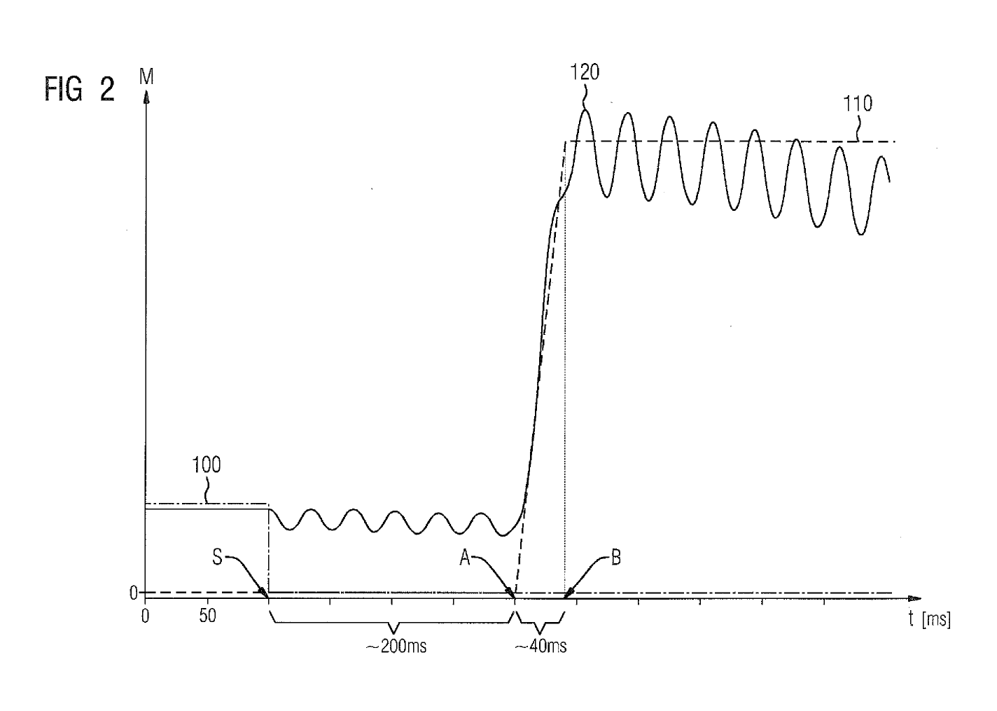

FIG. 2 shows a diagram illustrating the time scales arising during the braking processes.

FIG. 1 is a schematic diagram, not true to scale, of a motor-driven crane drive, in which an electric motor 1, for example a three-phase motor, drives a rope drum 3 via a gear unit 2. The motor 1 is supplied with electric current via a frequency converter 6.

A drive shaft 11 of the motor 1 is connected with an input shaft 21 of the gear unit 2 by means of a clutch device 30. A service brake 4 comprising a brake disk 41 connected non-rotatably to the clutch 30 and a brake caliper 40 is arranged on the clutch 30. Brake pads mounted in the brake caliper 40 may act from both sides on the brake disc 41. The service brake 4, on the fast side of the gear unit 2, is designed merely as a holding brake for the stationary drive system.

A rotational motion of the input shaft 21 of the gear unit 2 is geared down through three gear stages to slower rotational motion of the output shaft 22 of the gear unit 2. A rope drum 3 is connected non-rotatably to the output shaft 22. A safety brake 5 comprising a brake disk 51 connected non-rotatably to the rope drum 3 and a brake caliper 50 is arranged on the rope drum 3. Brake pads mounted in the brake caliper 50 may act from both sides on the brake disc 51. After arrival of an emergency stop signal, the rope drum brake 5 located on the slow side of the gear unit 2 is activated. The rope drum brake 5 engages in a very short time and with very significant force, in order to bring a load transported by the crane to a standstill as quickly as possible.

In an emergency, for example if a person is present in the hazard zone under a load, a crane driver may actuate an emergency stop switch 70, in order to bring the rope drum to a standstill as quickly as possible. On actuation of the emergency stop switch 70, a first emergency stop signal is generated and transmitted to a control device 80 via a first signal line 7. In the control device the incoming first emergency stop signal triggers a process over the course of which a second emergency stop signal is generated and transmitted via a second signal line 8 to the rope drum brake 5, and a third emergency stop signal is generated and transmitted via a third signal line 9 to the frequency converter 6.

The emergency stop signal arriving at the rope drum brake 5 there triggers activation of the rope drum brake 5, as a consequence of which rotation of the rope drum 3 is braked to a standstill and the rope drum 3 is kept at a standstill.

The emergency stop signal arriving at the frequency converter 6 there triggers activation or maintenance of an air gap torque of the electric motor 1 contrary to the direction of rotation of the motor. In the case of generator operation, the kinetic energy of the electric motor 1 is converted into electrical energy and either dissipated as heat via an electrical resistor (rheostatic brake) or fed back into an electric power grid 60 or a storage device (regenerative brake).

Activation of generator operation of the electric motor 1 leads to electric braking of the motor 1, i.e. the motor 1 itself generates a braking torque directed contrary to the rotational motion thereof. The peak load to be absorbed by the gear unit 1, which is generated in the gear unit 1 by braking of the inert mass of the fast side of the gear unit 1 after activation of the rope drum brake 5, is reduced significantly by electric braking of the motor 1, because the inert mass of the motor 1 does not or at least in part does not come into play as a result of electric braking thereof. The precise level of load reduction depends on the performance of the motor/converter combination, but generally amounts to no less than the simple rated torque of the gear unit 1. This reduction is possible because the converter 6 is regenerative and can feed the kinetic energy of the mechanical system regeneratively back into the grid 60.

The emergency stop signals sent by the control device 80 are timed such that the engaging of the rope drum brake 5 and the electric braking of the motor 1 takes place at the same time or the electric braking of the motor 1 takes place shortly, in particular in the region of up to a few tenths of a second, before the engagement of the rope drum brake 5. In this way it is ensured that the inert mass to be absorbed by the gear unit 1 is actually reduced. If the electric braking of the motor 1 were namely to be delayed relative to the engagement of the rope drum brake 5, a reduction in load would not be achievable.

The emergency stop signal which is generated by the emergency stop switch 70 and which serves to trigger the safety brake 5 is used in the control device 80 to generate a further emergency stop signal addressed to the converter 6 and thus to initiate electric braking of the motor 1.

FIG. 2 shows a diagram illustrating the time scales within which the braking processes take place. In the diagram, torques M are plotted against the time t in the unit ms for a lifting process in which a sudden emergency stop signal occurs. In the diagram, the air gap torque 100 of the motor, the braking torque 110 of the rope drum and the gear unit torque 120 are plotted.

First of all, a lifting process of a crane, as shown in FIG. 1, takes place: in the electric motor 1 a constant air gap torque 100 is present, which is transmitted to the gear unit 2 and there acts as a constant gear unit torque 120. The braking torque 110 of the rope drum is zero, since the safety brake 5 has not been activated.

At the time S. roughly at t=100 ms, an emergency stop signal occurs, which triggers motor 1 cutout. The air gap torque 100 of the motor 1 thereby drops immediately to zero. At the same time, the safety brake 5 is triggered by the emergency stop signal.

Between the time S of the emergency stop signal and the increase in braking torque 110 at the time A, there is a time interval of approximately 200 ms, in which the brake pads move from their resting position onto the brake disk. After the 200 ms, i.e. at the time A, the brake pads rest against the brake disk. From this time the contact pressure of the brake pads against the brake disk increases, which causes the steep rise in the braking torque 110 of the rope drum.

Between the time S of the emergency stop signal and the increase in braking torque 110 at the time A, the gear unit torque 120 oscillates sinusoidally around a slightly decreasing torque value: the motor torque no longer acts on the gear unit 2, but inertia allows the gear unit 2 to continue rotating. The slight falling trend of the mean gear unit torque 120 results from the only slowly relaxing rope, and the oscillation results from the sudden removal of stress from the gear unit 2.

As soon as the brake pads of the safety brake 5 are resting against the brake disk, the braking torque 110 of the rope drum increases sharply and reaches its maximum value after approximately 40 ms. The gear unit torque 120 rises at the same time and similarly abruptly, since now the inert mass of the elements of the drive train connected to the gear unit input shaft 21, in particular of the motor 1, the clutch 30 and the service brake 4, act on the gear unit 2 “from the front”, i.e. via the gear unit input shaft 21.

From the time B, i.e. the time at which the braking torque 110 on the rope drum has reached its maximum value, this braking torque 110 remains constant at its maximum value, since the safety brake 5 has reached its maximum braking action. immediately after the time B the gear unit torque 120 also reaches its maximum value; this value may be so high that the gear unit 2 is damaged. Once the maximum value of the gear unit torque 120 has been reached, the gear unit torque 120 oscillates sinusoidally around a gently decreasing torque value.

The present invention allows the maximum value of the gear unit torque 120 to be reduced considerably.

1.-5. (canceled)

6. A motor-driven crane drive, comprising:
a rope drum;
a gear unit;
a motor driving the rope drum via the gear unit; and
a safety brake arranged on a slower-rotating side of the gear unit, wherein a signal serving to trigger the safety brake is used to initiate electric braking of the motor.

7. The motor-driven crane drive claim 6, further comprising a frequency converter configured to control the motor.

8. The motor-driven crane drive claim 6, further comprising a control device configured to generate and determine a timing of the signal for initiating the electric braking of the motor.

9. The motor-driven crane drive claim 8 further comprising an emergency stop switch operably connected to the control device and configured such that upon actuation of the emergency stop switch an emergency stop signal is generated and transmitted to the control device to trigger the signal for initiating the electric braking of the motor.

10. The motor-driven crane drive claim 8 wherein the signal triggered in the control device is split into a first emergency stop signal to activate the safety brake and thereby cause a braking of the rope drum, and a second emergency stop signal transmitted to the frequency converter to cause the electric braking of the motor.

11. A method for operating a motor-driven crane drive, said method comprising:
arranging a safety brake on a slower-rotating side of a gear unit placed between a faster-rotating motor and a slower-rotating rope drum; and
initiating electric braking of the motor by the safety brake, when an emergency stop signal is activated to trigger the safety brake.

12. The method of claim 11, wherein the signal serving to trigger the safety brake is received in a control device, and further comprising, after receiving the signal the control device generating and determining a timing of an emergency stop signal for initiating the electric braking of the motor, and sending the emergency stop signal for initiating the electric braking of the motor to the motor or a converter supplying the motor.
